(19) United States
(12) Patent Application Publication
(10) Pub. No.: US 2009/0151966 A1
(43) Pub. Date: Jun. 18, 2009

(54) Switching Device For Impact Power Tool

(76) Inventor: Ting-Kuang Chen, Keelung (TW)

Correspondence Address: LIN & ASSOCIATES INTELLECTUAL PROPERTY, INC., P.O. BOX 2339, SARATOGA, CA, 95070-0339, US

(21) Appl. No.: 12/021,304

(22) Filed: Jan. 29, 2008

(30) Foreign Application Priority Data
Dec. 18, 2007 (TW) 096221532

(51) Int. Cl. B25D 17/00; B25D 16/00

(52) U.S. Cl. 173/48; 173/104

(57) ABSTRACT

A switching device for an impact power tool includes an input unit, a clutch unit, an output unit and a spring. The clutch unit is cooperated with the spring and located between the input unit and the output unit. The clutch unit includes a clutch disc connected to an input shaft of the input unit and a collar. The output unit includes an output shaft with struck blocks and a pounding member with striking blocks. When the collar is moved and connected with the clutch disc, the input shaft, the pounding member, the collar and the output shaft rotate simultaneously. The output shaft outputs rotation only. When the collar is moved and disengaged from the clutch disc, the input shaft drives the pounding member and the pounding member drives the output shaft to rotate. The output shaft outputs rotation with impact intermittently.

### BACKGROUND OF THE INVENTION

1. Field of the Invention

The present invention relates generally to a switching device for an impact power tool for switching two different operation modes such as rotation only and rotation with impact.

2. The Prior Arts

A conventional power tool for drilling and locking is to transfer the power from a motor to an output shaft via a gear unit which reduces or increases speeds of the output shaft. Some power tools include an impact function which allows the output shaft to apply a sudden torque to loosen or tighten the object.

The conventional impact power tool includes a motor, a first planetary gear unit, a clutch disk cooperated with a sun gear, a second planetary gear unit, a transmission shaft, an intermediate shaft, a pounding member and an output shaft. When the clutch disk moves axially to a first position, the transmission shaft is connected with the second planetary gear unit and engaged with the output shaft. The power is transmitted from the motor to the output shaft via the first planetary gear unit, the second planetary gear unit and the transmission shaft. The output shaft spins at a low speed, which can be used for drilling. When the clutch disk moves axially to a second position, the transmission shaft is disconnected from the second gear unit and the output shaft. The power is transmitted from the motor to the output shaft via the first planetary gear unit, the second planetary gear unit, the transmission shaft, the intermediate shaft and the pounding member. Thus, the output shaft spins at a high speed and provide an impact function, which can be used in an impact power screwdriver.

However, the conventional switching device for the impact power tool has a complicated structure and therefore demands a higher manufacturing cost.

### SUMMARY OF THE INVENTION

A primary objective of the present invention is to provide a switching device for an impact power tool to switch between a rotation output mode and a rotation with impact output mode, which overcomes aforementioned disadvantages of conventional designs.

A primary characteristic of the present invention is to provide an output switching device for an impact power tool having a simpler structure than the conventional switching tools. The switching device includes an input unit, a clutch unit, an output unit and a spring. The clutch unit is cooperated with the spring and located between the input unit and the output unit. The structure of the clutch unit is simpler than that of the conventional switching device. A user simply moves the clutch unit axially, and the power tool can provide an output in rotation only or in rotation with impact.

The switching device according to the present invention includes an input unit, a clutch unit, an output unit and a spring. The input unit includes an input shaft with two first spiral grooves defined on an outer periphery thereof. Steel balls are disposed in the first spiral grooves. Planet gears are engaged with the input shaft and a sun gear, which is engaged with the motor. Thus, the input shaft is driven by the motor.

The clutch unit includes a collar having two axial grooves in an inner periphery thereof and a clutch disc having two extension arms corresponding to the axial grooves. The clutch disc is connected to the input shaft and the extension arms are movably engaged with the axial grooves. A handle is connected to the collar so as to move the collar in an axial direction to control the engagement between the extension arms and the axial grooves.

The output unit includes an output shaft having two struck blocks and a pounding member having two striking blocks. The tubular pounding member includes two second spiral grooves corresponding to the first spiral grooves defined on an inner periphery thereof and the input shaft extends into the pounding member. The steel balls are engaged between the first spiral grooves and the second spiral grooves. Thus, when the input shaft rotates, the pounding member is driven to rotate by the steel balls. Two ribs extend from an outer periphery of the pounding member and are movably engaged with the axial grooves of the collar. Thus, the pounding member can drive the collar to rotate. The output shaft and the input shaft are axially movable to each other. The striking blocks can be in contact with the struck blocks so that the pounding member drives the output shaft.

The spring is disposed between the pounding member and the clutch disc. When the collar is moved to be engaged with the clutch disc, the input shaft simultaneously drives the pounding member, the collar and the output shaft to output power. When the collar is moved in opposite direction to be disengaged from the clutch disc, the input shaft drives the pounding member to rotate and then the pounding member drives the output shaft to rotate. When the output shaft has a resistance force applied thereon, the steel balls between the pounding member and the input shaft force the pounding member toward the input unit and the spring is compressed. An elastic restoring force will push the pounding member back to an original position. Therefore, the pounding member moves back and forth and provides the output shaft 44 with rotation and impact intermittently.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is an exploded view to show a switching device for an impact power tool in accordance with the present invention;

FIG. 1B is an exploded view to show the switching device of FIG. 1A viewed from another angle;

FIG. 2 is a partially exploded view showing the switching device in accordance with the present invention;

FIG. 3A is a perspective view of the switching device in accordance with the present invention;

FIG. 3B is a perspective view of the switching device in accordance with the present invention viewed from another angle;

FIG. 4A is a cross sectional view to show the switching device, wherein a collar is disengaged from a clutch disc;

FIG. 4B is a cross sectional view to show the switching device, wherein the collar is disengaged from the clutch disc and a pounding member is moved to compress a spring; and

FIG. 5 is a cross sectional view to show the switching device, wherein the collar is engaged with the clutch disc.

### DETAILED DESCRIPTION OF THE PREFERRED EMBODIMENT

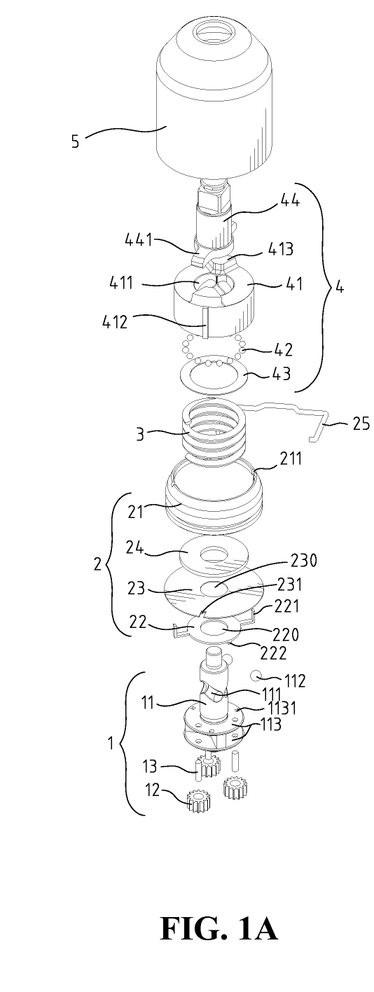

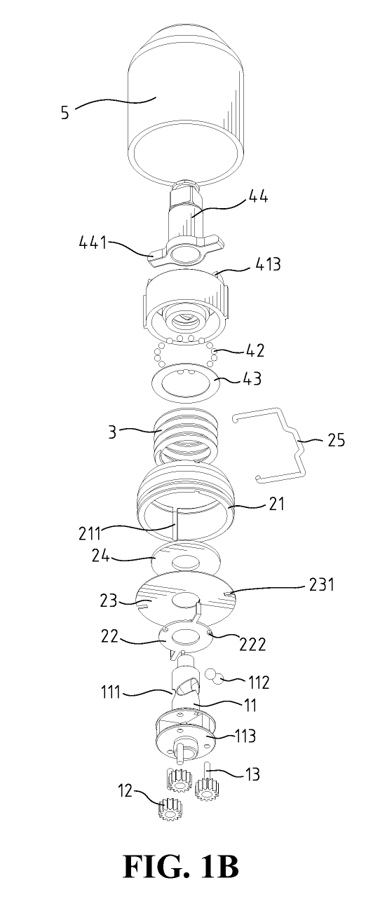

With reference to the drawings and in particular to FIGS. 1A and 1B, a switching device for an impact power tool in accordance with the present invention comprises an input unit 1, a clutch unit 2, a spring 3 and an output unit 4. A casing 5 is used to accommodate the switching device. In the following description, an upper side means a side close to the output unit 4 and a lower side means a side close to the input unit 1.

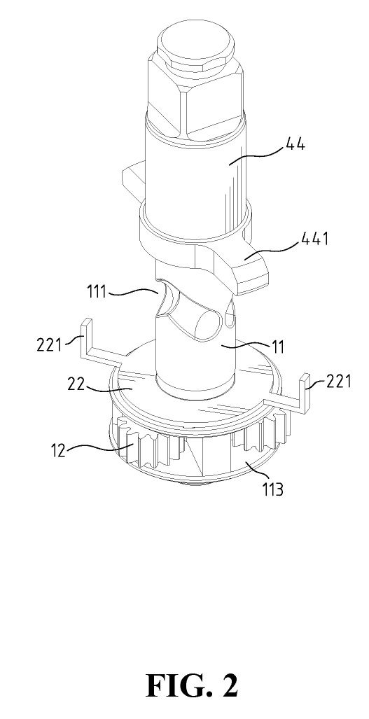

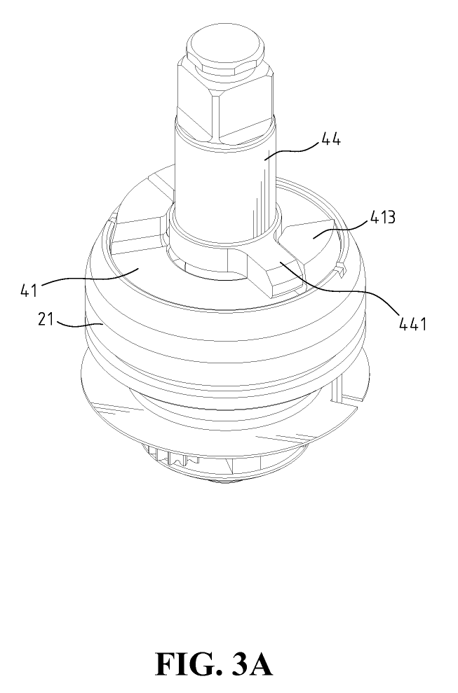

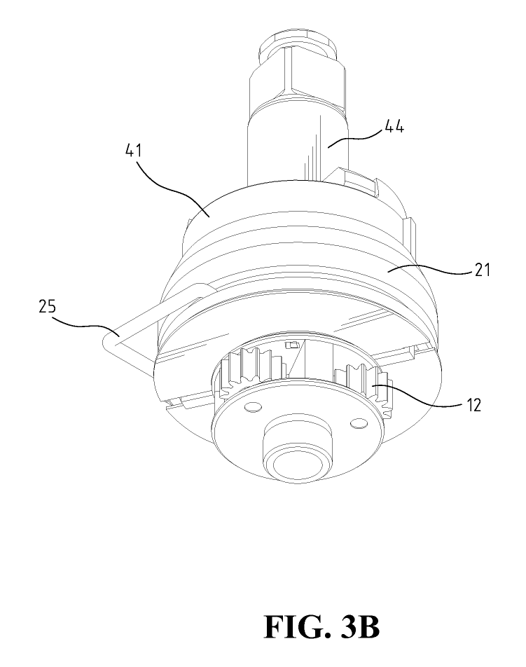

The input unit 1 includes an input shaft 11, which includes two first spiral grooves 111 defined on an outer periphery thereof and two steel balls 112 disposed in the two first spiral grooves 111 respectively. Two parallel flanges 113 are connected to a lower end of the input shaft 11 and three planet gears 12 are pivotally connected between the two flanges 113 by three pins 13 as shown in FIGS. 2 and 3B. The upper flange 113 includes a plurality of positioning holes 1131 defined therein. The input unit is mounted in the power tool. The power tool includes a motor and a gear unit connected to the motor (both not shown). The gear unit includes a sun gear engaged with the three planet gears 12. Thus, when the motor is activated, the input shaft 11 is driven by the planet gears 12.

The clutch unit 2 includes a clutch disc 22 and a collar 21. The clutch disc 22 includes two L-shaped extension arms 221 extending from an outer periphery thereof. The collar 21 has two axial grooves 211 corresponding to the extension arms 221 and defined on an inner periphery thereof. The extension arms 221 are movably engaged with the axial grooves 211. The clutch disc 22 includes a central hole 220 allowing the input shaft 11 to pass through. The clutch disc 22 includes protrusions 222 on a lower side thereof to be engaged with the positioning holes 1131 of the upper flange 113, thereby connecting the clutch disc 22 with the input shaft 11. By this way, the clutch disc 22 and the input shaft 11 are co-rotated. A first washer 23 and a second washer 24 are placed on the clutch disc 22 in sequence. The first washer 23 is larger than the second washer 24 and is placed on the clutch disc 22. The first washer 23 includes a central hole 230 defined at a center thereof and two notches 231 corresponding to the extension arms 221 and defined on the outer periphery thereof. The input shaft 11 extends through the central hole 230 and the extension arms 221 are engaged with the notches 231. The second washer 24 is smaller than the first washer 23. The input shaft 11 extends through a central hole of the second washer 24 and the second washer 24 is placed on the first washer 23. The tubular collar 21 includes an inner space to accommodate the input unit 1 and a handle 25 is connected to an outside of the collar 21. The collar 21 can be moved in an axial direction by operation of the handle 25 so as to control the engagement of the extension arms 221 with the axial grooves 211.

The spring 3 is a compression spring. The input shaft 11 extends through the spring 3 and the spring 3 is rested on the second washer 24.

The output unit 4 includes a tubular pounding member 41 and an output shaft 44. The pounding member 41 includes two second spiral grooves 411 corresponding to the first spiral grooves 111 and defined on an inner periphery thereof, two ribs 412 corresponding to the axial grooves 211 and symmetrically extended from an outer periphery thereof, and two striking blocks 413 symmetrically disposed on an upper end thereof. The input shaft 11 extends into a through hole of the pounding member 41. The second spiral grooves 411 receive the steel balls 112. The ribs 412 of the pounding member 41 are movably engaged with the axial grooves 211 of the collar 21. The output shaft 44 further includes a cavity defined at a lower end thereof and two struck blocks 441 corresponding to the striking blocks 413 and symmetrically extended out from a lower outer periphery thereof. When assembled, the pounding member 41 is disposed inside of the collar 21. The input shaft 11 passes through the through hole of the pounding member 41 and enters the cavity of the output shaft 44. The steel balls 112 are engaged between the first spiral grooves 111 of the input shaft 11 and the second spiral grooves 411 of the pounding member 41. The ribs 412 are slidably engaged with axial grooves 211 of the collar 21. Thus, the output shaft 44 and the input shaft 11 are axially movable to each other. A plurality of beads 42 are inserted in the pounding member 41 and a support ring 43 supports the beads 42. The spring 3 is disposed between the support ring 43 and the second washer 24. The casing 5 encloses all the parts mentioned above.

As shown in FIGS. 3A and 3B, each the struck blocks 441 of the output shaft 44 are located between the two striking blocks 413.

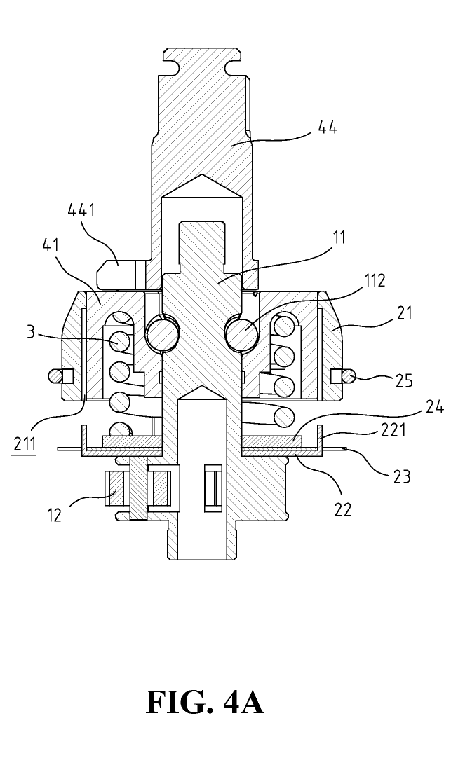

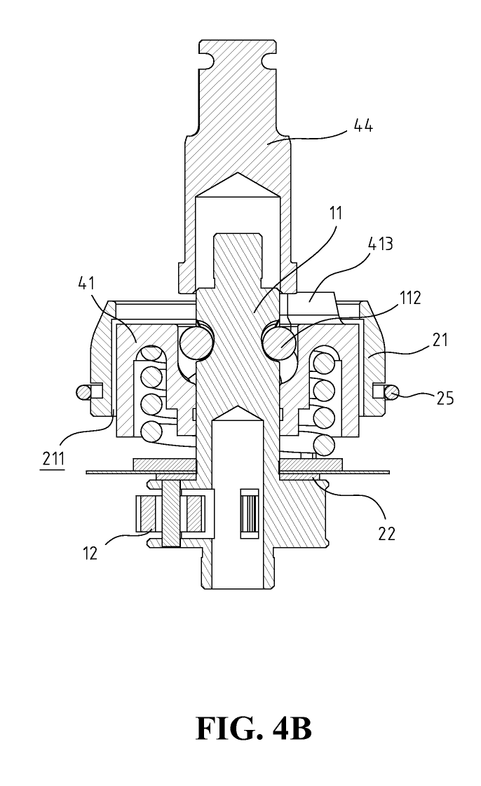

The switching device switches the output of the impact power tool between a first mode and a second mode. The first mode is that the output shaft 44 provides rotation and impact, and the second mode is that the output shaft 44 outputs rotation only. Referring to FIG. 4A, when the collar 21 is moved away from the clutch disc 22 by the handle 25, the power tool is set at the first mode. The extension arms 221 of the clutch disc 22 are disengaged from the axial grooves 211 of the collar 21. The lower end of the pounding member 41 is separated from the clutch disc 22 at a distance. When power of the impact power tool is on, the planet gears 12 are driven to rotate the input shaft 11 and the steel balls 112 engaged between the pounding member 41 and the input shaft 11 drive the pounding member 41 to rotate. The striking blocks 413 of the pounding member 41 strike the struck blocks 441 to rotate the output shaft 44. When the output shaft 44 is slowed down by a resistance, rotation of the pounding member 41 is restricted by the steel balls 112 and then the pounding member 41 is forced downward to release the restriction. The spring 3 is compressed by the pounding member 41 as shown in FIG. 4B. Then, elastic restoring force from the compressed spring 3 resumes the spring 3 back to an original un-compressed state and moves the pounding member 41 upward. Therefore, the pounding member 41 moves back and forth, and the striking blocks 413 of the pounding member 41 intermittently strike the struck blocks 441 of the output shaft 44. Thus, the output shaft 44 provides rotation and impact intermittently.

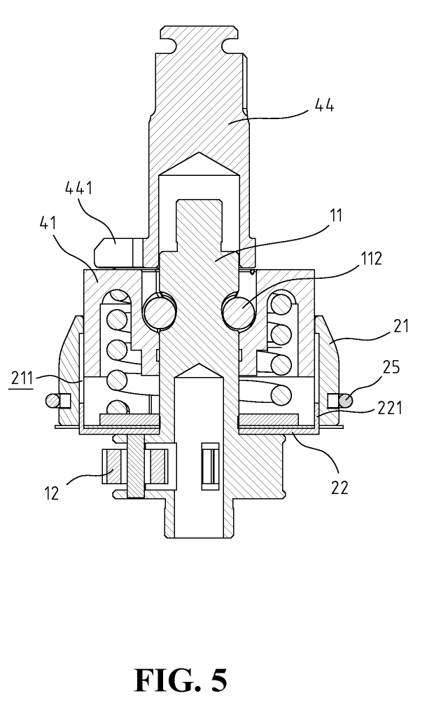

Referring to FIG. 5, when a user is going to set the impact power tool at the second mode, the collar 21 is moved toward the clutch disc 22 by the handle 25. The extension arms 221 are engaged with the axial grooves 211, thereby connecting the clutch disc 22 with the collar 21. Because the clutch disc 22 is co-rotated with the input shaft 11, the input shaft 11 drives the clutch disc 22, the collar 21, the pounding member 41 and the output shaft 44 to rotate simultaneously. Therefore, the output shaft 44 rotates continuously.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A switching device for an impact power tool, comprising:
an input unit comprising an input shaft, which includes two first spiral grooves defined on an outer periphery thereof and steel balls engaged with the first spiral grooves;
a clutch unit comprising a clutch disc having two extension arms extending from an outer periphery thereof and a collar having two axial grooves defined on an inner periphery thereof, the clutch disc connected to the input shaft and the extension arms movably engaged with the axial grooves;
an output unit comprising an output shaft having two struck blocks and a pounding member having two striking blocks, the pounding member including two second spiral grooves on an inner periphery thereof, the input shaft extending into the pounding member and the steel balls engaged with the second spiral grooves, two ribs extending from an outer periphery of the pounding member and movably engaged with the axial grooves, the output shaft and the input shaft being axially movable to each other; and
a spring biased between the clutch disc and the pounding member.

2. The device as claimed in claim 1, wherein the input shaft comprises a flange having positioning holes defined thereon, the clutch disc comprises protrusions corresponding to the positioning holes, and the protrusions are engaged with the positioning holes to connect the clutch disc with the input shaft.

3. The device as claimed in claim 1, wherein the extension arms are L-shaped members.

4. The device as claimed in claim 1 further comprising a handle connected to the collar.

5. The device as claimed in claim 1, wherein a first washer and a second washer are located on the clutch disc in sequence, an end of the spring is in contact with the second washer.
